(19) United States
(12) Patent Application Publication
(10) Pub. No.: US 2007/0055993 A1
(43) Pub. Date: Mar. 8, 2007

(54) Media content galleries

(75) Inventors: David A. Braun, Redmond, WA (US); Hugh C. Vidos, Sammamish, WA (US); Kort D. Sands, Seattle, WA (US); Matthew Goyer, Seattle, WA (US); Ryan J. D'Aurelio, Seattle, WA (US); Thomas H. Alphin, Kirkland, WA (US); William T. Flora, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/217,491

(22) Filed: Sep. 2, 2005

(51) Int. Cl. H04N 5/445; H04N 7/10; H04N 7/025; G06F 3/00; G06F 13/00

(52) U.S. Cl. 725/46; 725/48; 725/49; 725/34

(57) ABSTRACT

The invention discloses a system and method for displaying media content in a user interface. The invention can be configured to identify registered media content providers, and can aggregate media content from the media content providers into a single media gallery. The gallery can include a plurality of types of media content, and the media content can come from a plurality of media content provider types.

### CROSS-REFERENCE TO RELATED APPLICATION

Not applicable.

### STATEMENT REGARDING FEDERALLY SPONSORED RESEARCH OR DEVELOPMENT

Not applicable.

### BACKGROUND

Many different types of media content, including music content, radio content, and movie content, can be obtained by a user from a multitude of different media content providers. For example, a user can receive radio content from FM radio providers, satellite radio providers, and Internet radio providers. Another example can include obtaining movie content from a DVD changer, a video-on-demand provider, and a website. Currently, however, there is not a convenient way to organize and view different types of media content, such as Internet radio and FM radio content for example, in one gallery of media content. Also, there currently is not a convenient way to organize and view a specific kind of media content, movie content for example, obtained from a plurality of media content providers in one gallery of media content.

### SUMMARY

The invention discloses a system and method for displaying radio content in an user interface. The method can identify a content provider and can aggregate a plurality of radio content types from the content provider into a gallery. Once the gallery has been created, the gallery can be presented to a user in an user interface (UI). The invention also discloses a method for displaying movie content in an UI. The method can identify a movie content provider and can aggregate movie content from a plurality of movie content provider types into a gallery. Once the movie gallery has been generated, the movie content gallery can be presented to a user in an UI.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an embodiment of a system for aggregating media content into a gallery from a plurality of media content providers.

FIG. 2 illustrates an embodiment for generating a radio content gallery.

FIG. 3 illustrates an embodiment of an UI for displaying a radio content gallery.

FIG. 4 illustrates an embodiment of a method for generating a movie content gallery.

FIG. 5 illustrates an embodiment of an UI for displaying a gallery of movie content.

### DETAILED DESCRIPTION

The invention introduces a system and method for aggregating media content into one gallery to be displayed to a user. The invention can be configured to aggregate different types of media content from at least one media content provider into a gallery. The gallery can maintain a plurality of media content types so that a user can subsequently browse through the stored media content. The media content can be grouped into categories and can be searched by using identifiers such as the title of the movie content, release year, a name of a director, a name of actor, and type of movie content.

The invention encompasses a gallery for any type of media content including a radio content gallery and a movie content gallery. A radio content gallery can maintain different types of aggregated radio content including satellite radio, Internet radio, FM radio, and third party radio content applications from any number of radio content providers. A movie content gallery can maintain movie content from any type of movie content provider including a client's internal storage medium drive, an external storage medium drive, a recorded television movie provider, a video-on-demand provider, a server, and a website.

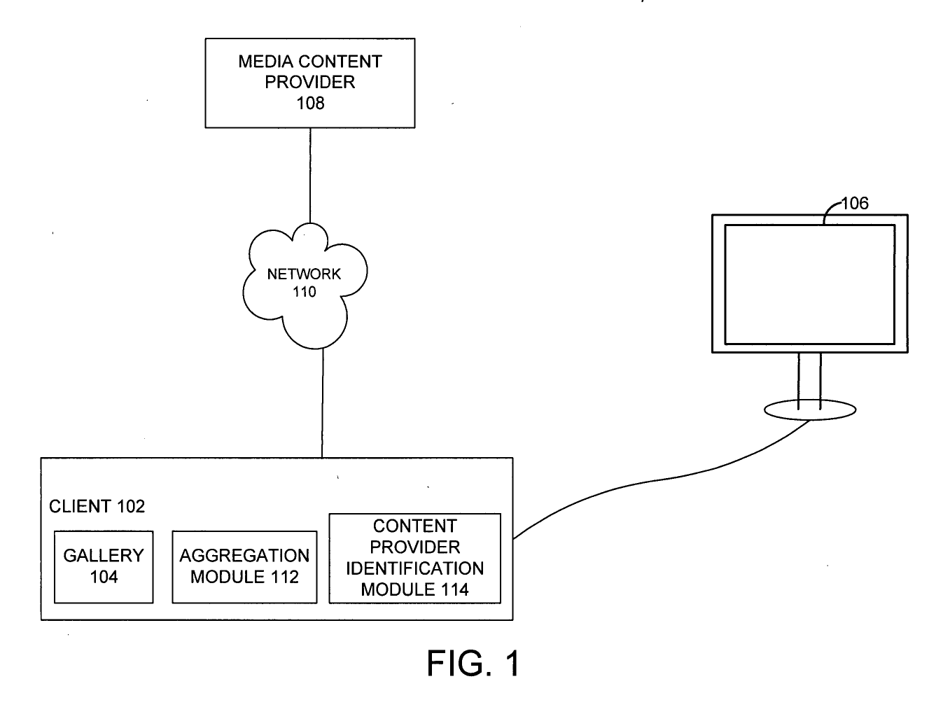

FIG. 1 illustrates an embodiment of a system for aggregating media content into a gallery from a plurality of media content providers. Client 102 may be or include a desktop or laptop computer, a network-enabled cellular telephone, wireless email client, or other client, machine or device to perform various tasks including Web browsing, search, electronic mail (email) and other tasks, applications and functions. Client 102 may be or can include a server including, for instance, a workstation running the Microsoft Windows®, MacOS™, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform. Client 102 may additionally include media devices such as digital still camera devices, digital video cameras, media players such as personal music players and personal video players, and other media devices.

Client 102 can include a communication interface. The communication interface may be an interface that can allow the client to be directly connected to media content provider 108 or allows the client 102 to be connected to the media content provider over network 10. Network 110 can include, for example, a local area network (LAN), a wide area network (WAN), or the Internet. In an embodiment, the client 102 can be connected to the media content provider 108 via a wireless interface. Client 102 can aggregate media content from a plurality of media content providers 108 in a single gallery 104. Media content maintained by gallery 104 can be displayed in an user interface (UI) on monitor 106. Client 102 can also include a content provider identification module that can identify registered media content providers 108. Additionally, client 102 can include an aggregation module 112 that can aggregate media content from media content providers into gallery 104.

In an embodiment, gallery 104 can include a plurality of radio content types including satellite radio, Internet radio, frequency modulation (FM) radio, and any other third party radio content application. In such an embodiment, media content provider 108 can comprise any type of radio content provider that can provide at least one of satellite radio, Internet radio, FM radio, and third party radio content applications. In another embodiment, gallery 104 can comprise movie content including any recorded movie. In such an embodiment, media content provider 108 can include internal storage media drives, external storage media drives, recorded television movie providers, video-on-demand providers, servers, and websites.

Radio Content Gallery

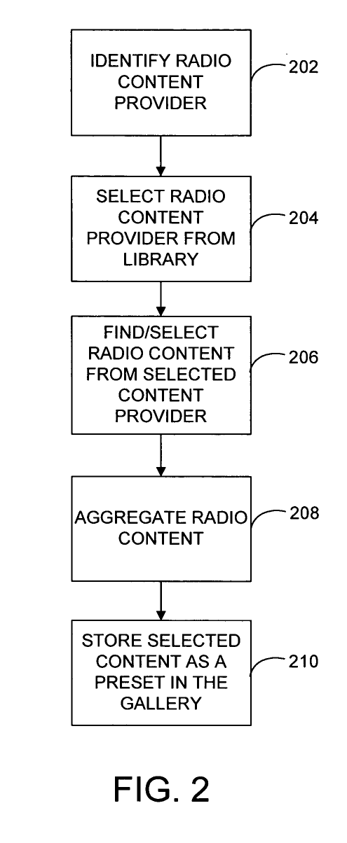

FIG. 2 illustrates an embodiment for generating a radio content gallery. A client can include software that can allow a user to generate a radio content gallery through use of content provider identification module 114 and aggregation module 112 (FIG. 1). Upon a first execution of the software, the user can be presented with a library of radio content providers from which the user can select a desired radio content provider at step 204. The library of radio content providers can include satellite radio providers, Internet radio providers, FM radio providers, and third party radio content applications. The library of radio content providers presented to the user can be predetermined by an original equipment manufacturer (OEM). The software can also add additional radio content providers utilizing a content provider identification module to identify other registered radio content providers at step 202.

Once a user has identified and selected a particular radio content provider of interest, the user can be presented with an UI of the selected radio content provider so that the user can search and select desired radio content at step 206. The radio content can include radio stations/programs offered by the selected radio content provider. Once the user finds and selects the radio content that the user is interested in, the user can aggregate the radio content into the user's radio content gallery through use of an aggregation module at step 208. The selected radio content can be maintained and stored as preset selections in the user's radio content gallery at step 210. By maintaining the selected radio content as a preset, the user can later go to his/her radio content gallery of preset radio content instead of having to search for the selected radio content again in the future. The invention can be configured to group the preset selections into categories that can be presented to a user. For example, the preset selections can grouped by name, by the radio content provider the radio content was received, by date added to the gallery, or any other grouping. The user can subsequently repeat the aforementioned steps to further add radio content from any other registered radio content provider into the user's radio content gallery.

The invention can be configured to allow a radio content provider to control playback of the radio content. For example, when a user chooses a radio content preset from his/her radio content gallery, the software can present the user with an UI that can start playback of the radio content, or an extensibility application can start playback of the radio content. The invention can also be configured to allow the software to control playback of FM radio content for clients that include FM tuners.

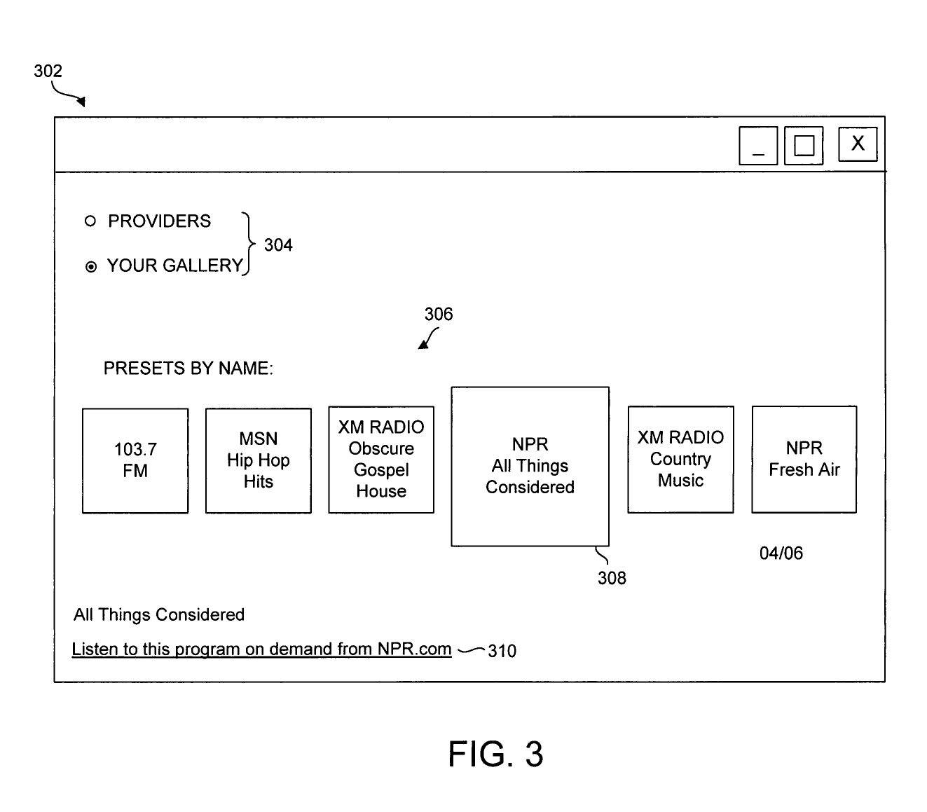

FIG. 3 is an embodiment of an UI for displaying a radio content gallery. The UI 302 can include a switching mechanism 304 to interchange between a library of radio content providers and a gallery of preset radio content. Section 306 can include a listing of preset radio content from any of the registered radio content providers. The listing of preset radio content can include satellite radio content, Internet radio content, FM radio content, or any other third party radio content application. A user can select a preset 308 and can be presented with a link 310 to a playback UI of the corresponding radio content provider that can control playback of the radio content.

Movie Content Gallery

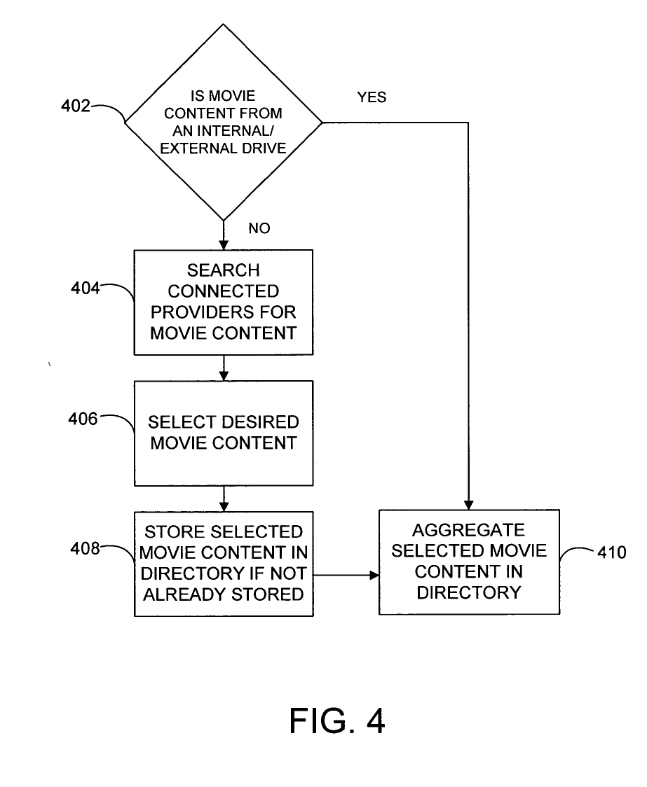

In an embodiment, the invention can be configured to generate a movie content gallery wherein gallery 104 (FIG. 1) comprises movie content. Movie content can include any form of a recorded movie. FIG. 4 illustrates an embodiment of a method for generating a movie content gallery. A user can generate a movie content gallery by aggregating movie content from any number of movie content providers. The different movie content providers can include a client's internal storage medium drive, external storage media drives, recorded television movie providers, video-on-demand providers, servers, and websites. Internal and external storage media drives can include, for example, DVD drives. At step 402, if an internal storage medium drive that contains movie content or if an external storage medium drive that contains movie content is identified by a content provider identification module, then the movie content can be aggregated into the movie content gallery at step 410. For example, movie content that is stored on a storage medium that is inserted into an internal storage medium drive of a client can be aggregated into the movie content gallery. In this example, there may not be a requirement to copy and store the movie content onto a hard drive of the client. In another example, an external storage medium drive connected to a client can contain movie content stored on storage media that can be aggregated into the movie content gallery. In this example, there may not be a requirement to copy and store the movie content onto a hard drive of the client. In such an example, when a user inserts the storage media into an external storage media drive a notification can be presented to the user asking the user to scan the storage media into the changer. Once the storage media has been scanned, the movie content can be aggregated into the movie content gallery.

However, a user can alternatively search for movie content through other identified movie content providers connected to the client at step 404. For example, a user can search through a listing of movies controlled by a recorded television movie provider, a video-on-demand movie provider, a server, a website, or a client's hard drive containing legally copied and stored movie content. In such an example, once a user selects a movie content that he/she is interested in obtaining, at step 406, the user can download and store the movie content in a designated movie directory on the client's hard drive at step 408. If the movie content came from the client's hard drive, there may not be a requirement to store the movie content in another location. Once the movie content has been stored, the movie content can be recognized and can be aggregated into the movie content gallery at step 410.

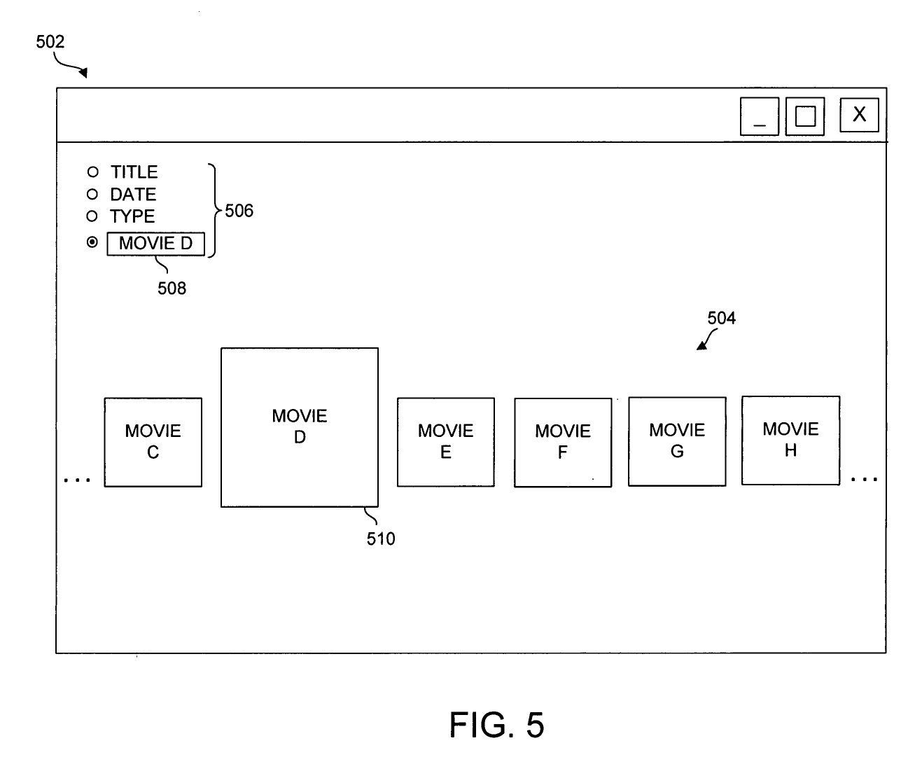

FIG. 5 illustrates an embodiment of an UI 502 for displaying a gallery of movie content. Once a movie content gallery, showing a listing of aggregated movie content 504, has been generated, a user can search for movie content by inputting identifiers into a search request input 506 or by selecting identifiers from a search request input 506. Such identifiers can include the title of the movie content, release year of the movie, a name of a director, a name of an actor, a movie type such as a DVD or recorded television movie, a genre, movie content added to the gallery most recently, or any other identifier that can locate desired movie content. The movie content gallery can have selectable identifiers that can organize and present a plurality of movie content in a group or in a particular order when a user selects the identifier. For example, a user can select an identifier such as “Title” that can organize movie content in the gallery in alphabetical order by title, or can allow a user search for movie content by inputting text corresponding to titles of movie content. Another example can be a user selecting an identifier such as “Date” that can organize the movie content in chronological order by dates of release, or can allow a user to search for movie content by inputting text corresponding to dates of release. Additionally, the identifier can include any other field of text that can be searched. For example, the user can enter the full name or part of the name of an actor or a director into a search request input 506. As shown in FIG. 5 a user can input an identifier, such as the title of a movie, into a text input field 508 which can search for movie content 510 that is related to the inputted identifier.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method for displaying media content in an user interface, comprising:
identifying at least one content provider;
aggregating a plurality of radio content types from the at least one content provider into a gallery; and
presenting the gallery in an user interface.

2. The method according to claim 1, wherein the plurality of radio content types includes at least two of Internet radio, satellite radio, FM radio, and third party radio content applications.

3. The method according to claim 1, wherein the plurality of radio content types includes Internet radio content types from two or more providers.

4. The method according to claim 1, wherein identifying the at least one content provider further comprises selecting the at least one content provider from a library of content providers.

5. The method according to claim 1, further comprising storing the plurality radio content types as preset selections in the gallery.

6. The method according to claim 1, further comprising presenting an user interface of the at least one content provider to control playback of the radio content.

7. The method according to claim 2, further comprising controlling playback of the FM radio content via an extensibility application.

8. The method according to claim 5, further comprising grouping the preset selections into categories.

9. A method for displaying media content in an user interface, comprising:
identifying at least one movie content provider;
aggregating movie content from a plurality of movie content provider types into a gallery; and
presenting the gallery in an user interface.

10. The method according to claim 8, wherein the movie content includes recorded movies.

11. The method according to claim 8, wherein the plurality of movie content provider types includes at least two of internal storage media drives, external storage media drives, recorded television movie providers, video-on-demand providers, servers, and websites.

12. The method according to claim 8, further comprising searching the gallery for movie content using identifiers.

13. The method according to claim 8, further comprising storing the movie content in a designated movie directory before aggregating the movie content into the gallery.

14. A system for displaying media content in an user interface, comprising:
a content provider identification module for identifying at least one content provider;
an aggregation module for aggregating a plurality of radio content types from the at least one content provider into a gallery; and
an user interface for displaying the gallery.

15. The system according to claim 14, wherein the plurality of radio content types includes at least two of Internet radio, satellite radio, FM radio, and a third party radio content application.

16. The system according to claim 14, wherein the plurality of radio content types includes Internet radio content types from two or more providers.

17. The system according to claim 14, wherein the at least one content provider is selected from a library of content providers.

18. The system according to claim 14, wherein the plurality radio content types are stored as preset selections in the gallery.

19. The system according to claim 14, wherein an user interface of the at least one content provider is used to control playback of the radio content.

20. The system according to claim 15, wherein playback of the FM radio content is controlled via an extensibility application.
